(19) United States
(12) Patent Application Publication
(10) Pub. No.: US 2007/0249212 A1
(43) Pub. Date: Oct. 25, 2007

(54) SYSTEM COMPRISING A HOUSEHOLD APPLIANCE AND A PEDESTAL OR BASE ASSEMBLY

(75) Inventors: Peter Buecker, Verl (DE); Andreas Kratzsch, Bielefeld (DE); Franz Maier, Guetersloh (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 11/737,431

(22) Filed: Apr. 19, 2007

(30) Foreign Application Priority Data
Apr. 25, 2006 (DE) 10 2006 019 608.2

(51) Int. Cl. H01R 13/62

(52) U.S. Cl. 439/369

(57) ABSTRACT

A system includes a household appliance, a pedestal and an interface. The household appliance includes a controller and a control panel. The control panel has a control element disposed therein. The pedestal includes a housing having an upper part providing a support surface for the household appliance. The pedestal also includes a drawer disposed in the housing, the drawer including a front panel covering a front of the housing and including a locking device operatively connected by a cable for locking and unlocking the locking device. The interface connects the cable to the pedestal and includes a male/female connector. A first part of the male/female connector is disposed on an underside of the household appliance, and a corresponding part of the male/female connector is disposed on the upper part of the housing of the pedestal so as to contact with the first part of the male/female connector.

Priority is claimed to German patent application DE 10 2006 019 608.2, filed Apr. 25, 2006, which is hereby incorporated by reference herein.

The present invention relates to a system comprising a household appliance, such as a washing machine, a laundry dryer, or the like, having a controller, a control panel and a control element located therein, the system further comprising a pedestal or base assembly having a housing, the upper part of which forms the support surface for the household appliance; a drawer or a hinged cover being located in the housing, and the front panel of the drawer, or the hinged cover, covering the front of the housing and being provided with a locking mechanism; the locking mechanism being coupled by a cable to the controller and/or to the control element of the appliance and operatively connected to said controller and/or said control element in such a manner that the locking mechanism can be locked or unlocked via a control element located in the control panel of the household appliance when said household appliance stands on the pedestal or base assembly.

### BACKGROUND

German Patent DE 10 2004 022 023 B3 describes a washing machine standing on a pedestal which is in the form of a base assembly and includes a housing in which is located a drawer. The drawer can be used, for example, to place a laundry basket thereon when in the extended position, or the drawer can also be used as a storage space for laundry to be washed, or for detergent. The housing of the pedestal is designed in terms of structural strength in such a way that the pedestal provides a sufficiently stable support surface for a machine. Moreover, it is known from DE 94 19 048 U1 to move the drawer by an electric motor, the electric motor being controlled by a switch on the washing machine. The connection between the motor in the pedestal and the switch on the washing machine is provided by a cable.

Another device is described in DE 203 02 572 U1. This device is a kind of base cabinet for the washing machine and has an extendable lockable drawer for storing detergent.

German Patent Application DE 38 33 962 A1 describes a laundry appliance having a door which is held closed by a locking mechanism. The locking mechanism can be locked or unlocked via a control element located in the control panel.

It is considered to be a disadvantage of these prior art embodiments that unlocking and locking can only be done in a stooped position, especially because the lock is located in a low position and, therefore, inconvenient to operate. Moreover, attention must be paid to the placement and correct connection of the cable during installation.

### SUMMARY

It is an aspect of the present invention to improve a system of the type mentioned at the outset in such a manner that the ease-of-use and handling during installation are significantly improved.

The present invention provides a system including a household appliance, a pedestal and an interface. The household appliance includes a controller and a control panel disposed therein, the control panel having a control element disposed therein. The pedestal includes a housing having an upper part providing a support surface for the household appliance. The pedestal includes a drawer disposed in the housing, the drawer including a front panel covering a front of the housing and including a locking device, the locking device being operatively connected by a cable to at least one of the controller and the control element so as to enable the locking device to be at least one of locked and unlocked via the control element when the household appliance is disposed on the pedestal. The interface is configured to connect the cable to the pedestal. The interface includes a male/female connector, a first part of the male/female connector being disposed on an underside of the household appliance, a corresponding part of the male/female connector being disposed on the upper part of the housing of the pedestal so as to contact with the first part of the male/female connector.

### BRIEF DESCRIPTION OF THE DRAWINGS

An exemplary embodiment of the present invention is shown in the drawings in a schematic way and will be described in more detail below. In the drawings,

FIG. 1 is a perspective view of the system;

FIG. 2 is an isolated perspective view of the pedestal or base assembly; and

FIGS. 3a, 3b are lateral views showing the system with the drawer pulled out and closed.

### DETAILED DESCRIPTION

Among the advantages provided by the present invention result from the fact that the drawer in the pedestal or base assembly can be remotely unlocked via the control panel of the household appliance. For this purpose, a control element, such as a simple switch, push button, or the like, can be provided in the area of the control panel and used to unlock or lock the locking mechanism, which may be accomplished by electromotive means. A signal connection is provided between the switch on the household appliance and the lock or locking mechanism. Thus, the locking mechanism is operatively connected to the controller of the appliance in such a manner that the locking mechanism can be locked or unlocked via a control element located in the control panel of the household appliance when said household appliance stands on the pedestal or base assembly.

The locking mechanism is connected to the controller and/or to the control element by a cable. For this purpose, it is convenient that the cable be connected to the pedestal via an interface. This allows for easy disconnection and connection. In an advantageous refinement, the interface provided is a male/female connector, one part of which is disposed and mounted on the underside of the household appliance. The corresponding part of the male/female connector is disposed and mounted in the upper part of the pedestal. In the installed and operative position, the two parts of the male/female connector are connected to and in contact with each other, thereby providing the connection between the control element and the locking mechanism.

The locking mechanism is controlled via the display of the control panel, for example, using a code or by means of a switch. The locking and unlocking operations may involve automatic retraction or extension of the drawer, respectively.

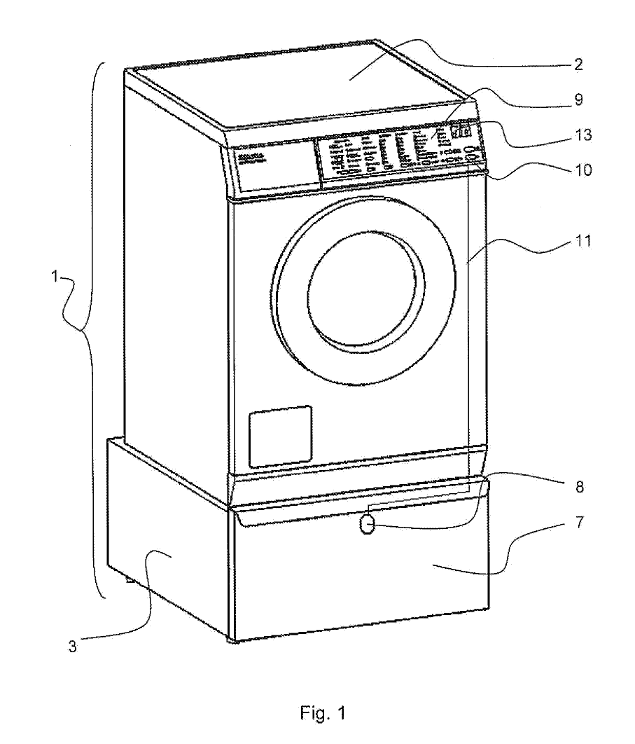

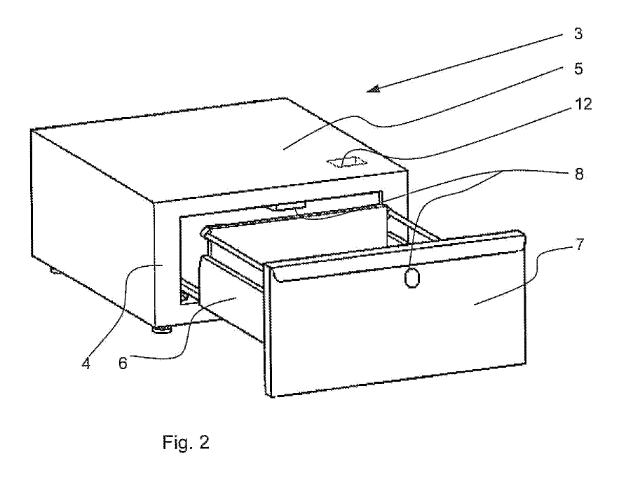

FIG. 1 is a perspective view showing a system 1 comprising a household appliance 2, such as a washing machine as shown here, and a pedestal or base assembly 3, as shown in more detail in FIG. 2. Pedestal or base assembly 3 includes a housing 4, the upper surface 5 of which forms the support surface for household appliance 2. As illustrated in particular in FIG. 2 in an exposed perspective view, housing 4 has located therein a drawer 6, which is in the extended position.

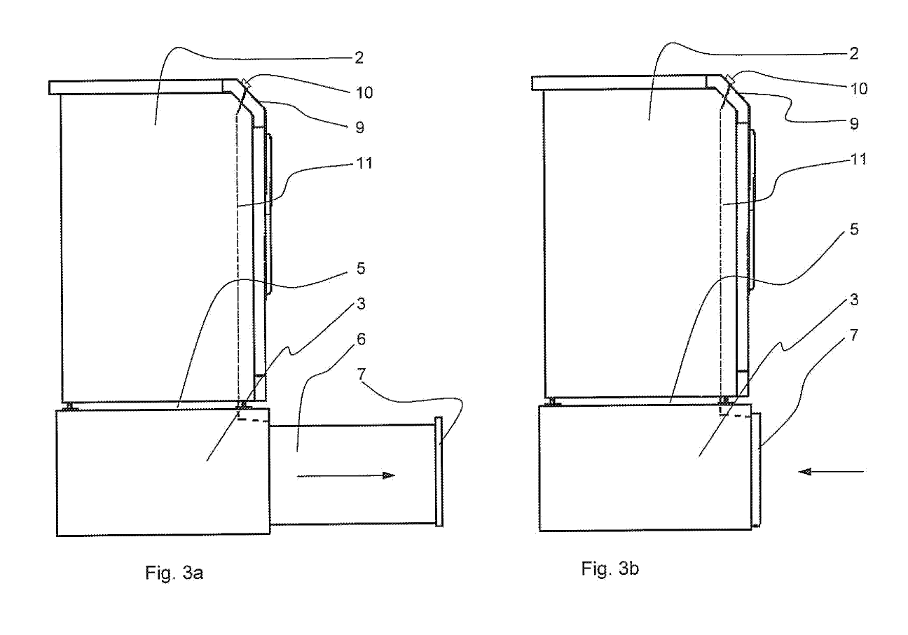

As can further be seen in FIG. 2, in particular from the perspective view, front panel 7 of drawer 6 covers the front of housing 4. Drawer 6 is equipped with a locking mechanism 8, which is located below upper surface 5 of housing 4. In accordance with the present invention, as illustrated in particular in FIG. 1, locking mechanism 8 is operatively connected to the controller of household appliance 2 in such a manner that locking mechanism 8 can be locked or unlocked via a control element 10 located in control panel 9 of household appliance 2 when said household appliance stands on pedestal or base assembly 3. This is shown, for example, in the lateral views of FIG. 3, one of which illustrates drawer 6 unlocked and extended while the other illustrates it retracted and locked.

Locking mechanism 8 is connected to the controller and/or to control element 10 by a cable 11. For the leading-through of cable 11, upper surface 5 of housing 4 has formed therein an opening 12 through which cable 11 is routed to locking mechanism 8, which here may be in the form of, for example, an electromagnetic switching device. In an advantageous embodiment, the cable 11 indicated in FIG. 1 and FIG. 3 is connected to a male/female connector located between household appliance 2 and pedestal 3. One part of the male/female connector is disposed and mounted in opening 12 in upper part 5 of pedestal 3, while the corresponding part of the male/female connector is disposed and mounted on the underside of household appliance 2. In this connection, it is convenient to position the male/female connector parts such that they provide the contact concurrently with the placement of appliance 2 on pedestal 3 or upper part 5, so that no additional installation effort is needed.

In a refinement of the present invention, drawer 6 can be locked and unlocked in display field 13 of control panel 9, for example, using a code or by means of a switch. As can be seen in particular in FIG. 3b, the locking of locking mechanism 8 may also involve automatic retraction of drawer 6 in the direction of the arrow, provided that suitable means are provided for this purpose in the area of housing 4. As can be seen in particular in FIG. 3a, the unlocking of locking mechanism 8 may also involve automatic extension of drawer 6 in the direction of the arrow.

While the invention has been particularly shown and described with reference to preferred embodiments thereof, it will be understood by those skilled in the art that various changes in form and details may be made therein without departing from the spirit and scope of the invention.

What is claimed is:

1. A system comprising:
a household appliance including a controller and a control panel disposed therein, the control panel having a control element disposed therein;
a pedestal including:
a housing having an upper part providing a support surface for the household appliance; and
a drawer disposed in the housing, the drawer including a front panel covering a front of the housing and including a locking device, the locking device being operatively connected by a cable to at least one of the controller and the control element so as to enable the locking device to be at least one of locked and unlocked via the control element when the household appliance is disposed on the pedestal; and
an interface configured to connect the cable to the pedestal, the interface including a male/female connector, a first part of the male/female connector being disposed on an underside of the household appliance, a corresponding part of the male/female connector being disposed on the upper part of the housing of the pedestal so as to contact with the first part of the male/female connector.

2. The system as recited in claim 1 wherein the household appliance includes at least one of a washing machine and a laundry dryer.

3. The system as recited in claim 1 wherein the pedestal includes a base assembly.

4. The system as recited in claim 1 wherein the display panel includes a display field useable to at least one of lock and unlock the locking device.

5. The system as recited in claim 4 wherein the display panel includes a display field useable to at least one of lock and unlock the locking device using a code.

6. The system as recited in claim 4 wherein the display panel includes a display field, the display field having a switch useable to at least one of lock and unlock the locking device.

7. The system as recited in claim 1 wherein the drawer is configured to automatically retract upon a locking of the locking device, and to extend upon an unlocking of the locking device.

8. A system comprising:
a household appliance including a controller and a control panel disposed therein, the control panel having a control element disposed therein;
a pedestal including:
a housing having an upper part providing a support surface for the household appliance; and
a hinged cover disposed in the housing, the hinged cover including a front panel covering a front of the housing and including a locking device, the locking device being operatively connected by a cable to at least one of the controller and the control element so as to enable the locking device to be at least one of locked and unlocked via the control element when the household appliance is disposed on the pedestal; and
an interface configured to connect the cable to the pedestal, the interface including a male/female connector, a first part of the male/female connector being disposed on an underside of the household appliance, a corresponding part of the male/female connector being disposed on the upper part of the housing of the pedestal so as to contact with the first part of the male/female connector.

9. The system as recited in claim 8 wherein the household appliance includes at least one of a washing machine and a laundry dryer.

10. The system as recited in claim 8 wherein the pedestal includes a base assembly.

11. The system as recited in claim 8 wherein the display panel includes a display field useable to at least one of lock and unlock the locking device.

12. The system as recited in claim 11 wherein the display panel includes a display field useable to at least one of lock and unlock the locking device using a code.

13. The system as recited in claim 11 wherein the display panel includes a display field, the display field having a switch useable to at least one of lock and unlock the locking device.
